(19) United States
(12) Patent Application Publication
(10) Pub. No.: US 2026/0267777 A1
(43) Pub. Date: Sep. 10, 2026

(54) TEST EXECUTION DEVICE, METHOD, AND A NON-TRANSITORY COMPUTER-READABLE MEDIUM

(71) Applicant: Hitachi, Ltd., Tokyo (JP)

(72) Inventor: Jun KITAWAKI, Tokyo (JP)

(73) Assignee: Hitachi, Ltd., Tokyo (JP)

(21) Appl. No.: 19/304,918

(22) Filed: Aug. 20, 2025

(30) Foreign Application Priority Data
Mar. 6, 2025 (JP) 2025-035390

(51) Int. Cl. G06F 11/3668

(52) U.S. Cl. CPC G06F 11/3684; G06F 11/3688; G06F 11/3696

(57) ABSTRACT

A test execution device for executing a plurality of tests on an application, the device including a memory and a processor, wherein the memory is configured to store management information that enables, for each of the tests, specifying a resource configuration of a testing environment where each of the tests can be executed, and the processor is configured to specify, based on the management information, a resource configuration of a testing environment used for execution of each of the tests, aggregate the tests for the respective resource configurations, construct a testing environment for each of the resource configurations, and sequentially execute, in the testing environments, the tests aggregated for the resource configurations of the testing environments.

### CROSS-REFERENCE TO RELATED APPLICATIONS

This application is based upon and claims the benefit of priority from Japanese Patent Application No. 2025-035390 filed in Japan Patent Office on Mar. 6, 2025, the contents of which are hereby incorporated by reference.

### BACKGROUND

The present disclosure relates to a technique for executing a test on an application.

A style has taken a hold in which services are provided promptly by developing an application in a short period of time using OSS (Open Source Software) or a commercial external library, and by running the application on a resource created on a public cloud. However, when implementing some sort of updates on applications running on a public cloud, such as not only when the applications themselves are updated to a new version but also when libraries close to EOL (End Of Life), managed services provided by the public cloud, or the platform alone are updated to a new version, regression testing needs to be performed in order to ensure that the applications run without any problems. Regression testing has many test items that need to be checked in order to ensure quality of the application, and therefore requires a long time. Even in a development environment where building and testing of the application are automatically executed late at night during which the application developer does not perform coding, regression testing takes a long time to complete.

Japanese Patent Application Publication No. 2018-139106 discloses a technique for efficiently executing a test by generating a script for executing a test for each operating environment (Web browser/OS/terminal), and by having a plurality of clients execute a test code in parallel.

### SUMMARY

However, in the method described in Japanese Patent Application Publication No. 2018-139106, since the application to be tested is not parallelized, when executing a test that creates a period during which the application does not elicit normal functions, such as a test for restarting a database which is a component of the application, other tests that are executed in parallel during the period might fail. By constructing many independent testing environments and executing tests in the respective testing environments in parallel, making use of advantages of a public cloud that can create resources dynamically, a plurality of tests may be able to be executed in parallel without regard to the impact on other tests, and it is considered that this may lead to a decrease in the amount of time necessary to complete all the tests. However, in a pay-as-you-go public cloud, even for a time until testing starts after resources are created and the application and database are initialized, usage fees for the resources are incurred, and this results in a cost increase.

One of the objects of the present disclosure is to provide a technique capable of reducing the costs while shortening the time it takes for a test.

One aspect of the present disclosure is a test execution device described below: A test execution device for executing a plurality of tests on an application, the device including a memory and a processor, wherein the memory is configured to store management information that enables, for each of the tests, specifying a resource configuration of a testing environment where each of the tests can be executed, and the processor is configured to specify, based on the management information, a resource configuration of a testing environment used for execution of each of the tests, aggregate the tests for the respective resource configurations, construct a testing environment for each of the resource configurations, and sequentially execute, in the testing environments, the tests aggregated for the resource configurations of the testing environments.

According to one aspect of the present disclosure, costs can be reduced while shortening the time it takes for a test.

### BRIEF DESCRIPTION OF THE DRAWINGS

FIG. 1 is a block diagram showing a configuration of a test execution device;

FIG. 2 is a block diagram showing a hardware configuration of the test execution device;

FIG. 3 is a diagram for explaining an example of a testing environment;

FIG. 4 is a diagram showing an example of a test item table;

FIG. 5 is a diagram showing an example of a configuration of a test item/test type mapping table;

FIG. 6 is a diagram showing an example of a configuration of a resource/configuration change table;

FIG. 7 is a diagram showing an example of a configuration of a test item/resource mapping table;

FIG. 8 is a flowchart showing a flow of testing environment determination processing;

FIG. 9 is a diagram showing an example of a configuration of an IaC storage table;

FIG. 10 is a diagram showing an example of a file read by IaC change processing;

FIG. 11 is a flowchart showing a detailed flow of the IaC change processing;

FIG. 12 is a diagram showing an example of a configuration of a test execution table;

FIG. 13 is a flowchart showing a detailed flow of testing environment construction processing;

FIG. 14 is a flowchart showing a detailed flow of test execution processing;

FIG. 15 is a diagram showing an example of a test execution status screen displayed by test execution status presentation processing;

FIG. 16 is a block diagram showing a configuration of the test execution device;

FIG. 17 is a diagram showing an example of a test item table of Embodiment 2; and

FIG. 18 is a flowchart showing a flow of the testing environment determination processing.

### DETAILED DESCRIPTION OF THE EMBODIMENT

Embodiments of the present invention will now be described with reference to the drawings.

A test execution device is a device for executing a plurality of tests on an application. Keeping the costs down while reducing the time it takes for a test is required in execution of a test.

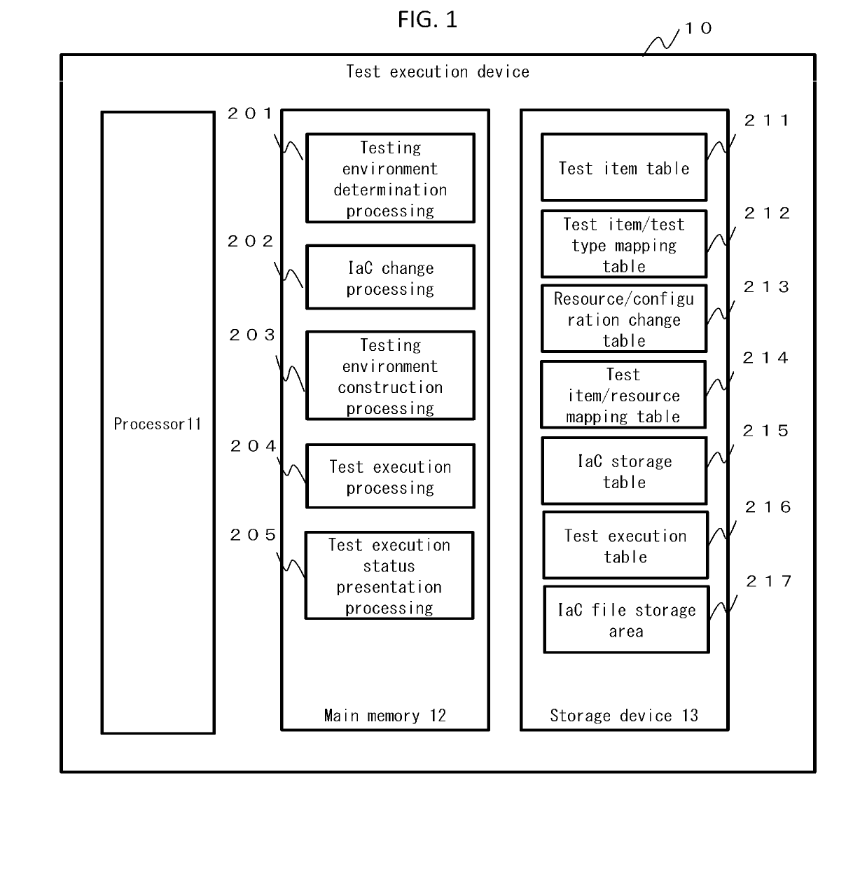

FIG. 1 is a block diagram showing a configuration of the test execution device.

A test execution device 10 includes a processor 11, a main memory 12, and a storage device 13. Various types of management information are stored in the storage device 13. Based on the management information on the storage device 13, the processor 11 executes software programs of various types of processing on the main memory 12, thereby implementing functions of the test execution device 10.

The management information is information that enables, for each test, specifying a resource configuration of a testing environment where each test can be executed. Based on the management information, the processor 11 specifies a resource configuration of a testing environment used for executing each of the plurality of tests. Resource configurations are defined by conditions that are required for each resource in order to execute a test and verify an item to be verified in the test. For example, a testing environment is constructed on a public cloud, and the processor 11 constructs a testing environment by a resource provided in the public cloud. The processor 11 also aggregates tests for the respective specified resource configurations, constructs a testing environment with respect to each resource configuration, and sequentially executes, in the testing environments, the tests aggregated with respect to the resource configurations of the testing environments. After finishing all the tests aggregated for the resource configurations of the respective testing environments, the processor 11 deletes resources of the testing environments on the public cloud. In this manner, the tests are aggregated for the respective resource configurations of the testing environments, each testing environment is constructed, and a test is executed for each testing environment, thereby keeping the costs down while reducing the time it takes for a test.

In the present embodiment, the management information may also be information that enables, for each of the tests, specifying an execution time which is the time it takes for executing each of the tests. In a case where a sum of execution time of the tests for the respective testing environments exceeds a predetermined threshold, the processor 11 may also divide the tests aggregated for the resource configurations into a plurality of tests, construct a plurality of testing environments for the resource configurations, and execute these tests separately in the plurality of testing environments. Accordingly, since the testing environments are constructed and the tests are executed separately so that the execution time for each testing environment does not exceed the threshold, the time it takes for a test can be reduced to the required time, and at the same time the costs can be kept down.

More specific embodiments of the present embodiment will be described below.

### Embodiment 1

A test execution device according to Embodiment 1 has the configuration shown in FIG. 1. Referring to FIG. 1 again, as a software program running on the main memory 12, there is a software program for executing each of testing environment determination processing 201, IaC change processing 202, testing environment construction processing 203, test execution processing 204, and test execution status presentation processing 205.

The testing environment determination processing 201 is a processing for specifying test types for respective test items, specifying resource configurations for the respective test types, and determining testing environments to be prepared, based on the specified resource configurations. The IaC change processing 202 is a processing for changing IaC (Infrastructure as Code) information in accordance with each of the determined testing environments. IaC is a method that defines a testing environment by using code and constructs a testing environment on the basis of a file defined by the code, and IaC is popular for efficient application development.

Examples of IaC include an IaC service provided by AWS (Amazon Web Service). AWS and Amazon are registered trademarks. IaC information before change is information indicating an actual application execution environment by using code. Not all tests require the same configuration as the actual execution environments. Depending on the test, the objectives of the test can be achieved by executing and verifying it in a partially degenerated testing environment. In such a case, the test may be executed using a testing environment obtained after a resource is deleted or reduced from the original execution environment. The changed IaC information indicates a changed testing environment. The testing environment construction processing 203 is a processing for constructing a testing environment in accordance with the changed IaC information. The test execution processing 204 is a processing for executing a test in a constructed testing environment. The test execution status presentation processing 205 is a processing for presenting, to a user, the status in which a test is executed.

As the management information on the storage device 13, there are a test item table 211, a test item/test type mapping table 212, a resource/configuration change table 213, a test item/resource mapping table 214, an IaC storage table 215, a test execution table 216, and an IaC file storage area 217.

Information related to test items of a plurality of tests to be executed on an application are stored in the test item table 211. Information indicating mapping between test items and test types of the respective tests are stored in the test item/test type mapping table 212.

Information indicating performances and configurations of the respective resources for the testing environments of the respective test types are stored in the resource/configuration change table 213. The performances and configurations for the respective resources are indicated by changes from the original execution environments.

Information indicating performances and configurations of the respective resources for the testing environments of the respective test items of the respective tests in accordance with changes from the original execution environments are stored in the test item/resource mapping table 214.

The test execution table 216 stores, for the respective tests, information indicating the statuses of the respective tests and testing environments.

The IaC storage table 215 stores, for each testing environment, information indicating mapping between a storage location of IaC information indicating the original execution environment and a storage location of IaC information indicating the testing environment (testing environment after change). The IaC file storage area 217 stores a file describing IaC information indicating the resource configuration of each testing environment.

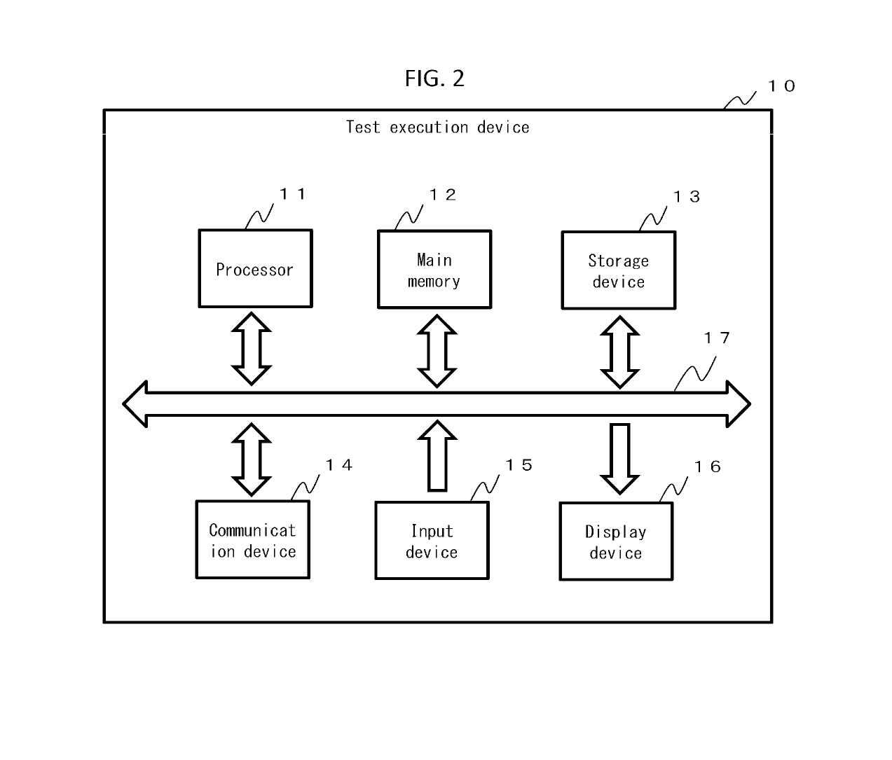

FIG. 2 is a block diagram showing a hardware configuration of the test execution device.

The test execution device 10 is a computer having a communication device 14, an input device 15, and a display device 16 in addition to the processor 11, the main memory 12, and the storage device 13, wherein all of these devices are coupled with one another by a bus 17. The communication device 14 is coupled to an application to be tested, a test client executing the test, and a public cloud constructing a testing environment, via a network. The input device 15 inputs information to a table set in the storage device 13. The display device 16 displays and outputs information such as an execution result of the processor 11.

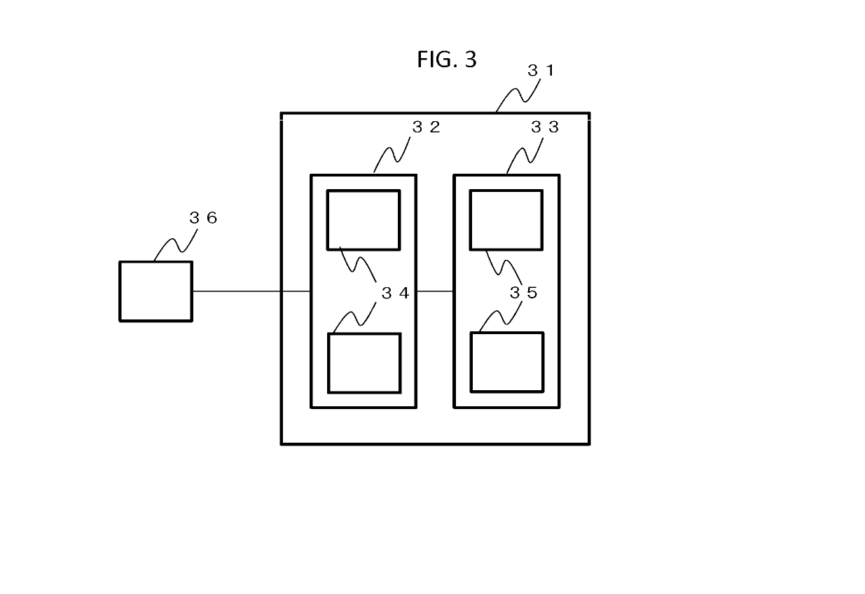

FIG. 3 is a diagram for explaining an example of a testing environment. As described above, testing environments are constructed on the public cloud. When executing a test, an application 31 to be tested runs in a testing environment on the public cloud.

The application 31 is roughly divided into a service portion 32 and a database portion 33. In the service portion 32, an instance or a container 34 performing processing implements a computing function, and in order to achieve higher availability, a plurality of instances or containers 34 performing the same processing are run internally to form a redundant configuration, so that even when one of the plurality of instances or containers 34 stops, provision of computing services continues. Further, in the database portion 33 as well, a database 35 for storing data in a predetermined data structure implements a database function, and in order to achieve higher availability, a plurality of databases 35 storing the same data are run internally to form a redundant configuration, so that even when one of the plurality of databases 35 stops, provision of the database function continues.

A test client 36 may be present on the public cloud or in a network within an organization that uses the public cloud. The test client 36 transmits a request message to an IP address called a representative address of the service portion 32 of the application 31 or an FQDN (Fully Qualified Domain Name) resolved by a DNS (Domain Name System). The instance or container 34 that receives the request message in the service portion 32 transmits a query to the database portion 33 as needed, to request an operation on the database 35. The database portion 33, too, uses a representative address so that the service portion 32 does not have to be concerned about whether the database 35 receives a query or not.

A method of test execution in the test execution device 10 configured as described above will now be described hereinafter.

The test execution method includes the testing environment determination processing 201, the IaC change processing 202, the testing environment construction processing 203, the test execution processing 204, and the test execution status presentation processing 205.

Testing Environment Determination Processing 201

The test item table 211, the test item/test type mapping table 212, the resource/configuration change table 213, and the test item/resource mapping table 214 will be described as the management information used in the testing environment determination processing 201.

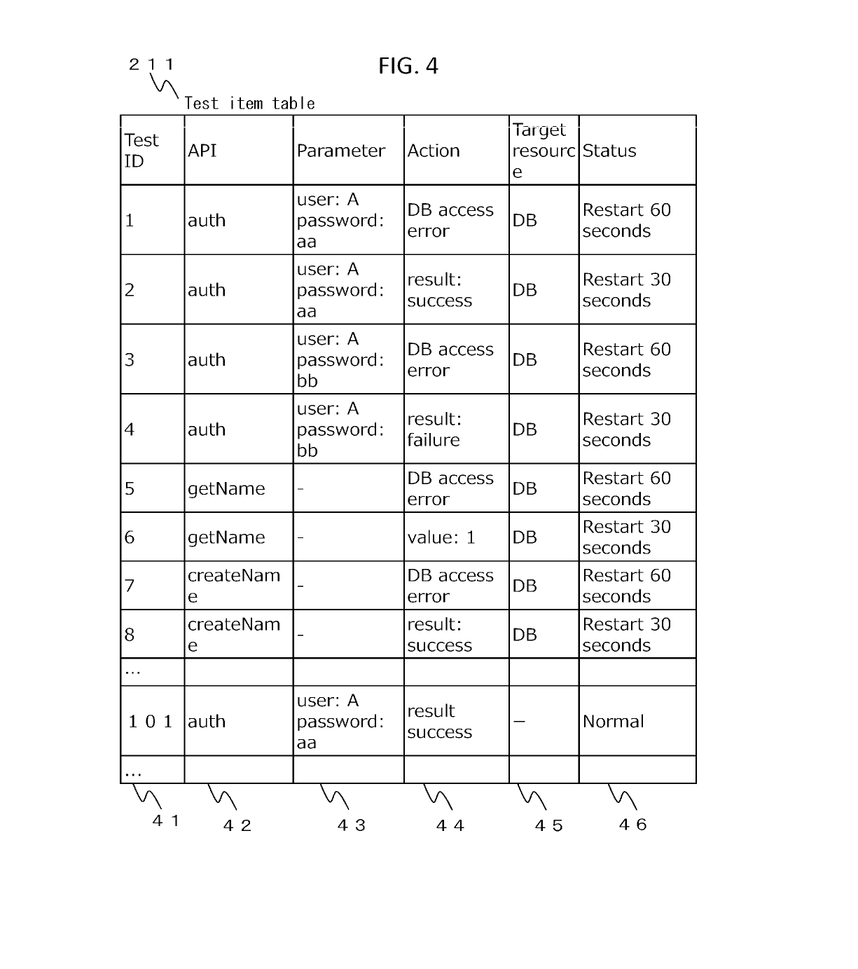

FIG. 4 is a diagram showing an example of the test item table.

The test item table 211 is composed of a test ID 41 for storing unique values for identifying test items, an API 42 for storing API (Application Programming Interface) of request messages transmitted from the test client 36 to the service portion 32, a parameter 43 for similarly storing parameter portions of the request messages, an action 44 for storing anticipated responses from the application 31, a target resource 45 for storing a function subject to failure when causing some sort of failure in the application 31 for the purpose of testing, and a status 46 for storing statuses of failures.

Testing is now described using a row in which the value of the test ID 41 is 1. In testing of this test item, in a status where the database is being restarted, which takes 60 seconds, a request message is transmitted to an API called auth indicating authentication, the request message being configured by a parameter in which value A is stored in a key called user and value aa is stored in a key called password. In this testing, the application is expected to respond with an error message “DB access error.”

Contents of the test item table 211 are created in advance by a developer or a person in charge of testing at the time of application development.

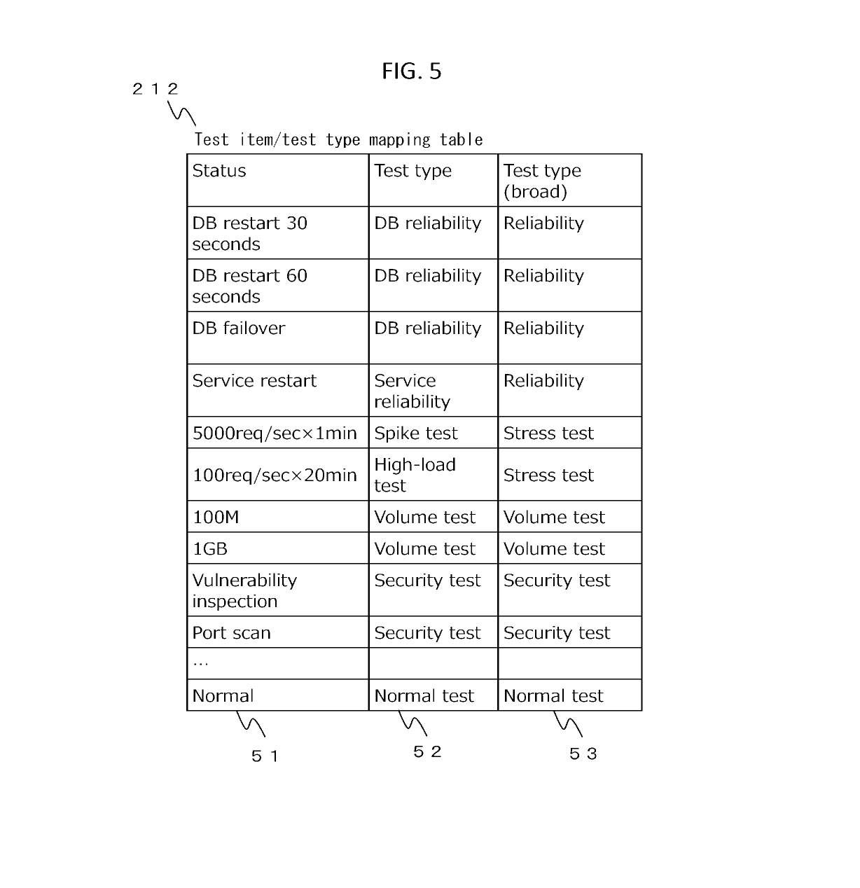

FIG. 5 is a diagram showing an example of a configuration of the test item/test type mapping table.

The test item/test type mapping table 212 is composed of, for respective tests, a status 51 for storing values corresponding to the statuses 46 of the test item table 211 set when executing the tests, a test type 52 for storing test types corresponding to the tests, and a test type (broad) 53 for categorizing the test types of the tests into broader types.

Description is provided using the first row and the second row. DB restart and DB failover are categorized into the same DB reliability as the test types, and are categorized into reliability as the test types (broad). The test item/test type mapping table 212 is created by a person in charge prior to testing. The test item/test type mapping table 212 may be created in units of applications to be developed, or may be created and managed as a table shared by a plurality of applications within an organization.

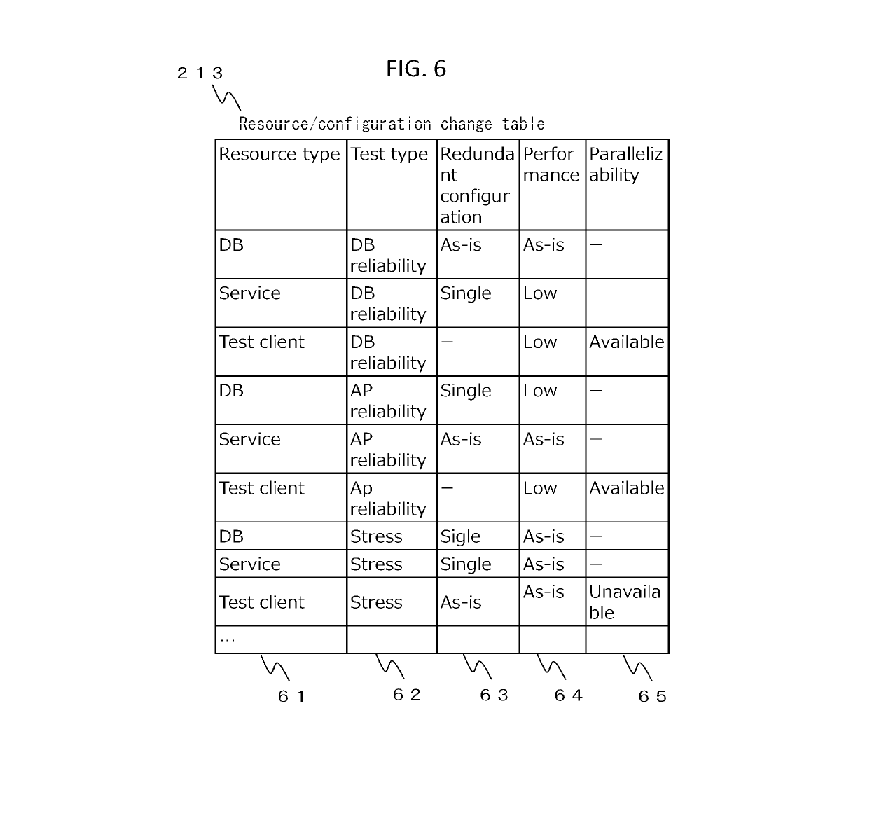

FIG. 6 is a diagram showing an example of a configuration of the resource/configuration change table.

The resource/configuration change table 213 is information indicating which testing environment of a resource configuration that has changed from the original operating environment can be used. The resource/configuration change table 213 is composed of a resource type 61 for storing resource types, a test type 62 for storing test types, a redundant configuration 63 for storing changeability of redundant configurations of the resources, a performance 64 for storing changeability of performances of the resources, and a parallelizability 65 for storing whether a test client can be used with a plurality of test items or not.

Here, the resources include a database providing a database function and a service providing a computing function. The performance of the database refers to, for example, a storage capacity or a reading and writing speed. The performance of the service refers to, for example, a clock speed or the number of threads in computing. In the original operating environment, the service providing a computing function and the database providing a database function have a duplexing redundant configuration. Therefore, a notation of “as-is” for the redundant configuration in the table indicates that the same duplexing redundant configuration as that of the original operating environment is adopted. Further, a notation of “single” for the redundant configuration in the table indicates that the original duplexing redundant configuration can be changed to a single redundant configuration. In addition, a notation of “as-is” for the performance in the table indicates that the same performance as that of the original operating environment is adopted. Also, a notation of “low” for the performance in the table indicates that the performance is lower than that of the original operating environment.

Description is provided using the first to third rows. The first to third rows store information about a test whose test type is DB reliability. In the first row, DB shows that the redundant configuration remains as the original operating environment (as-is), and the performance also remains as the original operating environment (as-is). In the second row, the service indicates that the redundant configuration can be changed to single, and the performance also can be low. In the third row, the test client shows that the performance can be low, and the test client can be used together with other testing environment. The resource/configuration change table 213 is created by a person in charge prior to testing. The resource/configuration change table 213 may be created in units of applications to be developed, or may be created and managed as a table shared by a plurality of applications within an organization.

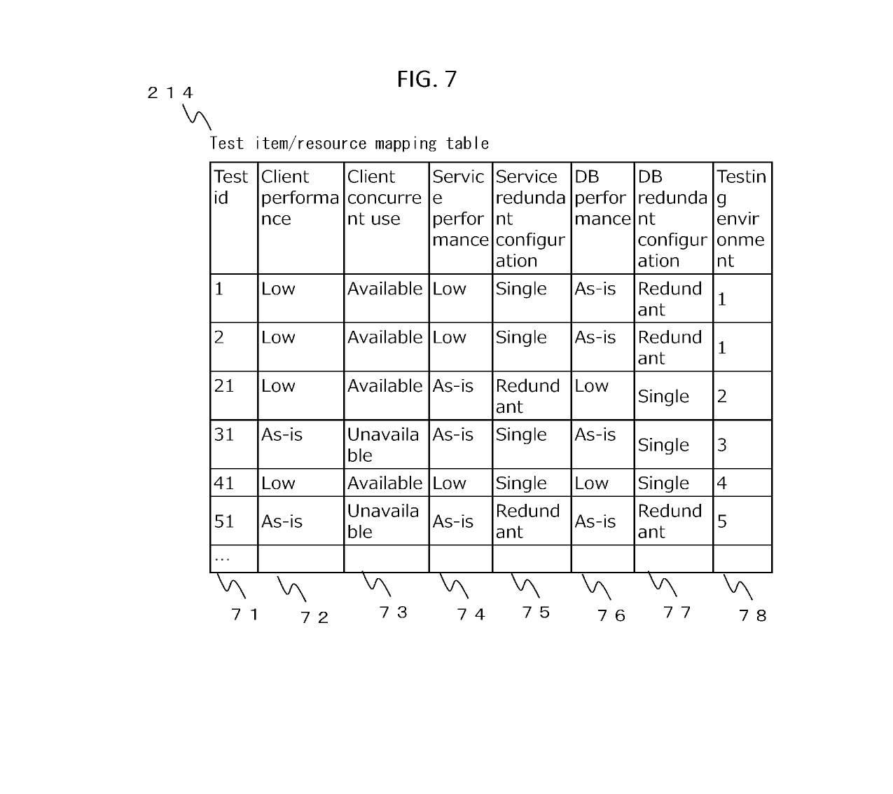

FIG. 7 is a diagram showing an example of a configuration of the test item/resource mapping table.

The test item/resource mapping table 214 is composed of a test ID 71 for storing values corresponding to the values of the test ID 41 of the test item table 211, a client performance 72 for storing values indicating performances of test clients, a client concurrent use 73 for storing whether a test client is used together with other testing environment, a service performance 74 for storing values indicating performances of services, a service redundant configuration 75 for storing value indicating redundant configurations of services, a DB performance 76 for storing values indicating performances of databases, a DB redundant configuration 77 for storing values indicating redundant configurations of databases, and a testing environment 78 for storing values uniquely indicating testing environments.

The test item/resource mapping table 214 is created based on the contents of the test item table 211, the test item/test type mapping table 212, and the resource/configuration change table 213.

The testing environment determination processing 201 will be described next.

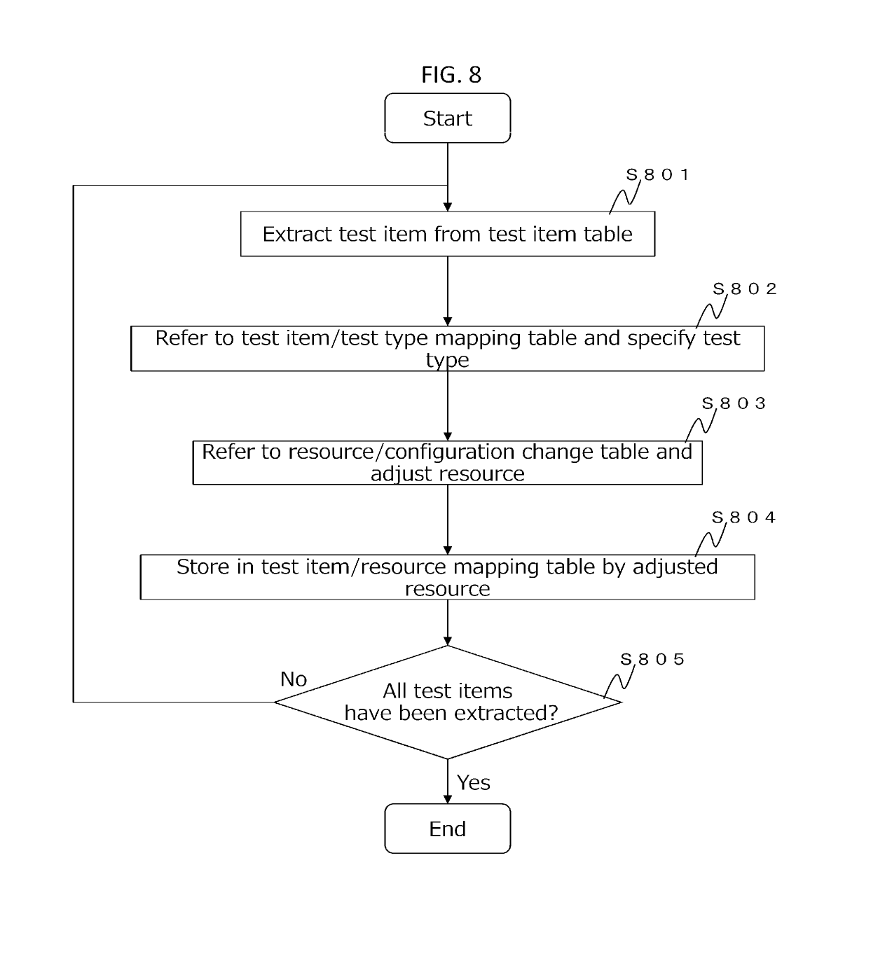

FIG. 8 is a flowchart showing a flow of the testing environment determination processing.

The testing environment determination processing 201 is a processing realized by the processor 11 executing a software program, and the testing environment determination processing 201 can be said to be the operating entity. The processing is now described below with the testing environment determination processing 201 as the entity.

An initial state of the test item/resource mapping table 214 is empty. The testing environment determination processing 201 first extracts one row out of the test items from the test item table 211 (S801). Next, the testing environment determination processing 201 refers to the test item/test type mapping table 212 to select a row in which the value of the status 51 matches a combination of the values of the target resource 45 and status 46 of the test item extracted in step S801 (S802).

Then, the testing environment determination processing 201 acquires the values of the resource type 61, the redundant configuration 62, the performance 64, and the parallelizability 65 of the row in the resource/configuration change table 213 where the value of the test type 52 of the row selected in step S802 matches, and then holds the acquired values internally together with the value of the test ID 41 of the row of the test item table 211 extracted in step S801 (S803).

Based on the information on the table obtained in steps S801, S802, S803, the testing environment determination processing 201 inserts a new row into the test item/resource mapping table 214 (S804).

In doing so, as a value for each column of the new row, first, the value of the ID 41 of the test item table 211 extracted in step S801 is copied to the test ID 71. Here, the number of rows having a specific value of the test type 62 in the resource/configuration change table 213 is the number of resource types. In the present embodiment, there are three types, “DB,” “service,” and “test client.” Thus, from the rows in the resource/configuration change table 213 where the values of the resource type 61 show “DB,” the values of the redundant configuration 63 are copied to the DB redundant configuration 77 of the new rows and the values of the performance 64 are copied to the DB performance 76 of the new rows. Subsequently, from the rows in the resource/configuration change table 213 where the values of the resource type 61 show “service,” the values of the redundant configuration 63 are copied to the service redundant configuration 75 of the new rows and the values of the performance 64 are copied to the service performance 74 of the new rows. Then, from the rows in the resource/configuration change table 213 where the values of the resource type 61 show “test client,” the values of the performance 64 are copied to the client performance 72 of the new rows and the values of the parallelizability 65 are copied to the client concurrent use 73 of the new rows.

Further, when the existing rows that are inserted thus far in the test item/resource mapping table 214 have rows that completely match with the new rows in terms of the values of the client performance 72, the client concurrent use 73, the service performance 74, the service redundant configuration 75, the DB performance 76, and the DB redundant configuration 77, the values of the testing environment 78 of said rows are copied to the testing environment 78 the new rows. If there are no existing rows that completely match with the new rows in terms of the values of the client performance 72, the client concurrent use 73, the service performance 74, the service redundant configuration 75, the DB performance 76, and the DB redundant configuration 77, a value obtained by adding 1 to the maximum value of the values of the testing environment 78 in the existing rows, which are inserted thus far into the test item/resource mapping table 214, is stored in the testing environment 78. If the test item/resource mapping table 214 is empty, that is, if there are no existing rows, 1 is stored in the testing environment 78 of the new rows. Then, a newly created new row is inserted at the end of the test item/resource mapping table 214.

Next, the testing environment determination processing 201 determines whether the row extracted from the test item table 211 in step S801 is the last row or not (S805). If the extracted row is the last row, the testing environment determination processing 201 is ended. If the extracted row is not the last row, that is, if there is another row, the testing environment determination processing 201 returns to step S801.

IaC Change Processing 202

The IaC storage table 215, which is management information used in the testing environment determination processing 201, is now described.

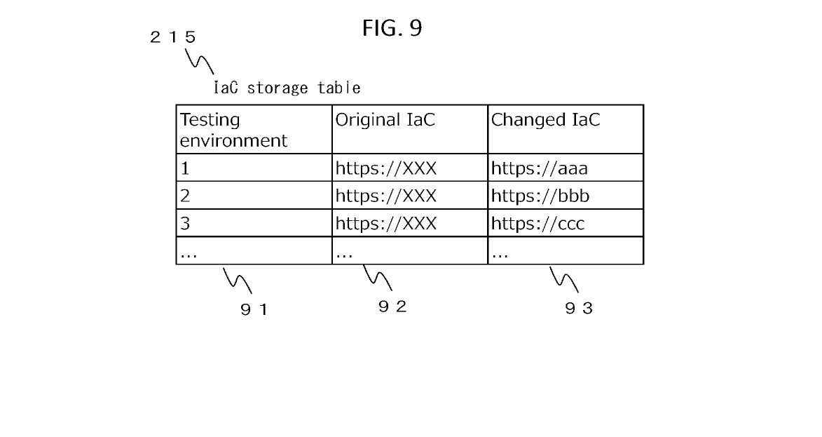

FIG. 9 is a diagram showing an example of a configuration of the IaC storage table.

The IaC storage table 215 is composed of a testing environment 91 for storing values corresponding to the testing environment 78 of the test item/resource mapping table 214, an original IaC 92 for storing locations of original IaCs indicating the original operating environments of the testing environments, and a changed IaC 93 for storing locations of IaCs obtained by changing the original IaCs. A method for creating the IaC storage table 215 will be described later.

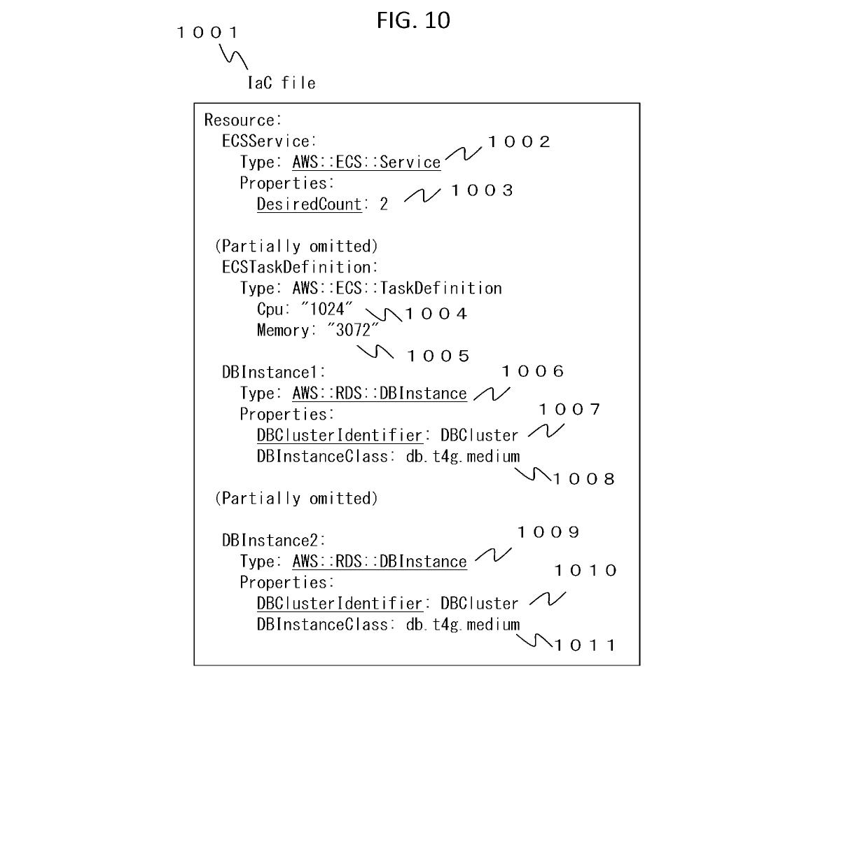

FIG. 10 is a diagram showing an example of a file read by the IaC change processing. As an example of the file by an IaC service provided by AWS, FIG. 10 shows an excerpt of an IaC file 1001 that is written in YAML (YAML Ain’t Markup Language) format used in Cloud Formation.

The IaC file 1001 includes a row 1002 indicating a service portion as a resource to be created, a row 1003 indicating the number when a redundant configuration is provided, a CPU clock number 1004 allocated to containers when services are containers, and a memory size 1005. As to a database, also included are rows 1006, 1009 indicating instances having database functions, rows 1007, 1010 indicating identifiers for uniquely specifying clusters when an instance having a plurality of database functions takes a redundant configuration as one database function, and rows 1008, 1011 indicating instance performances. A method for showing the instance performance includes directly designating a CPU frequency of memory size, and designating a type indicating the performance prepared by a public cloud provider, as in the row 1011. In regards to the type indicating the performance prepared by a public cloud provider, the public cloud provider publicizes the type by an official document and publicizes support of a specific CPU frequency or memory size.

Accordingly, in case of service functions, information on how many services are to be run can normally be obtained from the value of the row 1003. In case of database functions, information on how many database instances are to be run within the database function can be obtained by specifying the same cluster from the values of the rows 1007, 1010 and then counting the number of instances of the rows 1006, 1009.

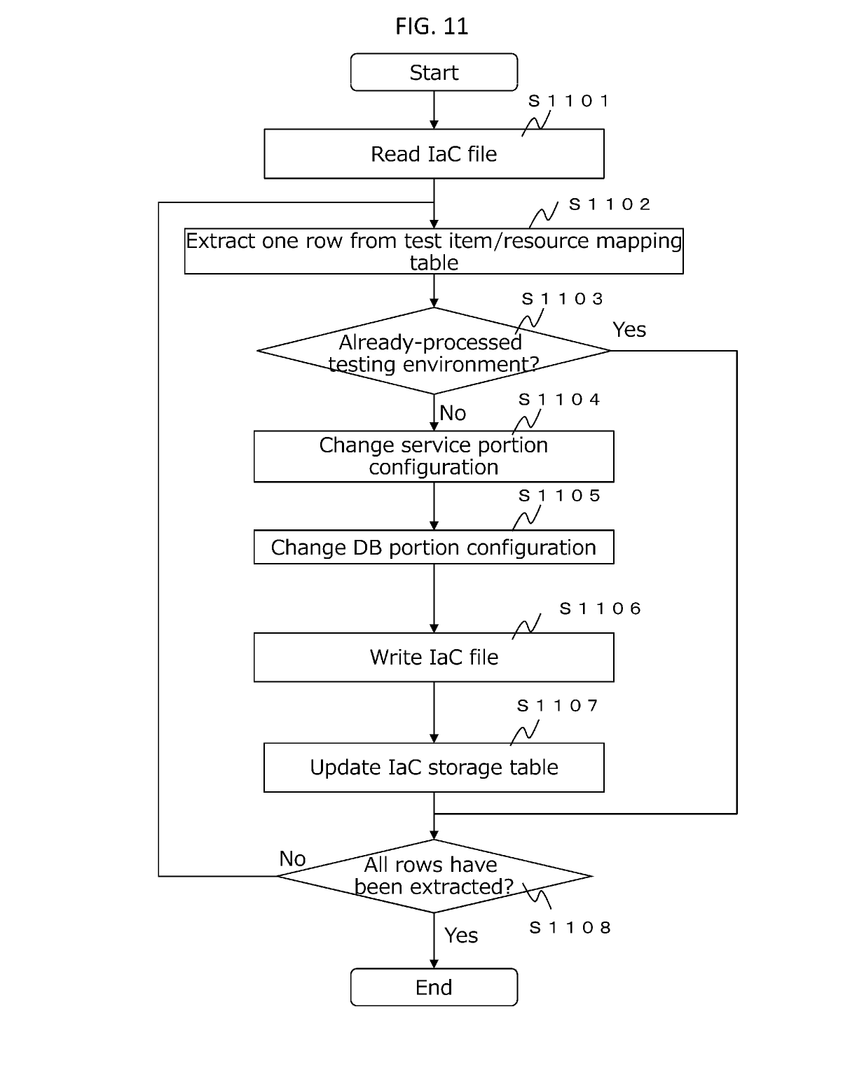

FIG. 11 is a flowchart showing a detailed flow of the IaC change processing.

The IaC change processing 202 is a processing realized by the processor 11 executing a software program, and the IaC change processing 202 can be said to be the operating entity. The processing is now described below with the IaC change processing 202 as the entity.

The IaC change processing 202 is executed after the testing environment determination processing 201 is completed and the creation of the test item/resource mapping table 214 is completed.

First, the IaC change processing 202 reads an IaC file from the IaC file storage area 217 located on the storage device 13 of the test execution device 10 (S1101). Next, the IaC change processing 202 extracts one row from the test item/resource mapping table 214 (S1102). The IaC change processing 202 then determines whether the value of the testing environment 78 extracted in step S1102 is the value of the already processed testing environment or not (S1103).

If the value of the testing environment 78 extracted in step S1102 is the value of the already processed testing environment, the IaC change processing 202 proceeds to step S1108 or otherwise proceeds to step S1104.

In step S1104, the IaC change processing 202 changes the configuration of the service portion of the IaC file 1001. Specifically, the value of the service performance 74 in the row extracted in step S1102 is referenced from the test item/resource mapping table 214, and if the value is “low,” the performances 1004, 1005 of the resources associated with the service of the IaC file 1001 are changed to a performance lower than the original performance. Further, the value of the service redundant configuration 75 is referenced, and if the value is “single,” the numerical value 1003 indicating the redundant configuration of the information of a resource associated with the service of the IaC file 1001 is changed to 1.

Subsequently, in step S1105, the IaC change processing 202 changes the configuration of the database portion in the same manner as changing the configuration of the service portion in step S1104. Specifically, the value of the DB performance 76 of the row extracted in step S1102 is referenced from the test item/resource mapping table 214, and if the value is “low,” the values of the rows 1008, 1011 indicating the performances of the instances in the IaC file 1001 are changed to low values. In addition, the value of the DB redundant configuration 77 is referenced, and if the value is “single,” the rows related to the instances in the IaC file 1001 are grouped into one (S1105). In the present embodiment, DBInstance 2 is deleted, and DBInstance 1 remains.

Next, the IaC change processing 202 stores, in the IaC file storage area 217, a changed IaC file containing the configuration of the service portion changed in step S1104 and the configuration of the database portion changed in step S1105, and holds the storage location internally (S1106).

Further, the IaC change processing 202 updates the IaC storage table 215 so as to record the location of the changed IaC file (S1107). Specifically, the location of the IaC file read in step S1101 is stored in the original IaC 92, the location of the changed IaC file held internally in step S1101 is stored in the changed IaC 93, the row, in which the value of the testing environment 78 of the row extracted from the test item/resource mapping table 214 in step S1102 is stored in the testing environment 91, is inserted into the IaC storage table 215, and the value of the testing environment is held internally.

Next, the IaC change processing 202 determines whether the row extracted from the test item/resource mapping table 214 in step S1102 is the last row or not (S1108). If the row is the last row, the IaC change processing 202 ends the processing, and if the row is not the last row, the IaC change processing 202 returns to step S1102.

Testing Environment Construction Processing 203

The test execution table 216, which is management information used in the testing environment construction processing 203, is now described.

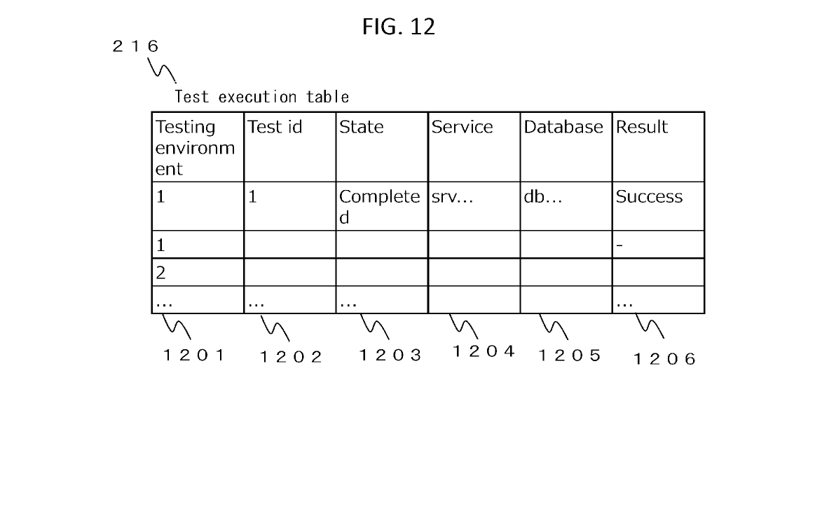

FIG. 12 is a diagram showing an example of a configuration of the test execution table.

The test execution table 216 is composed of a testing environment 1201 for storing values corresponding to the values of the testing environment 78 of the test item/resource mapping table 214, a test ID 1202 for storing values corresponding to the values of the test ID 41 of the test item table 211, a state 1203 for storing values indicating the states of test items indicated by the values of the test ID 1202, a service 1204 for storing representative addresses of service functions in testing environments indicated by the values of the testing environment 1201, a database 1205 for storing representative addresses of database functions in testing environments indicated by the values of the test 1201, and a result 1206 for storing test results of the test items indicated by the values of the test ID 1202. The test execution table 216 constructs testing environments by the testing environment construction processing 203, is sequentially updated in response to status changes of the testing environments while a test is executed by the test execution processing 206, and is initialized during the test execution processing 206.

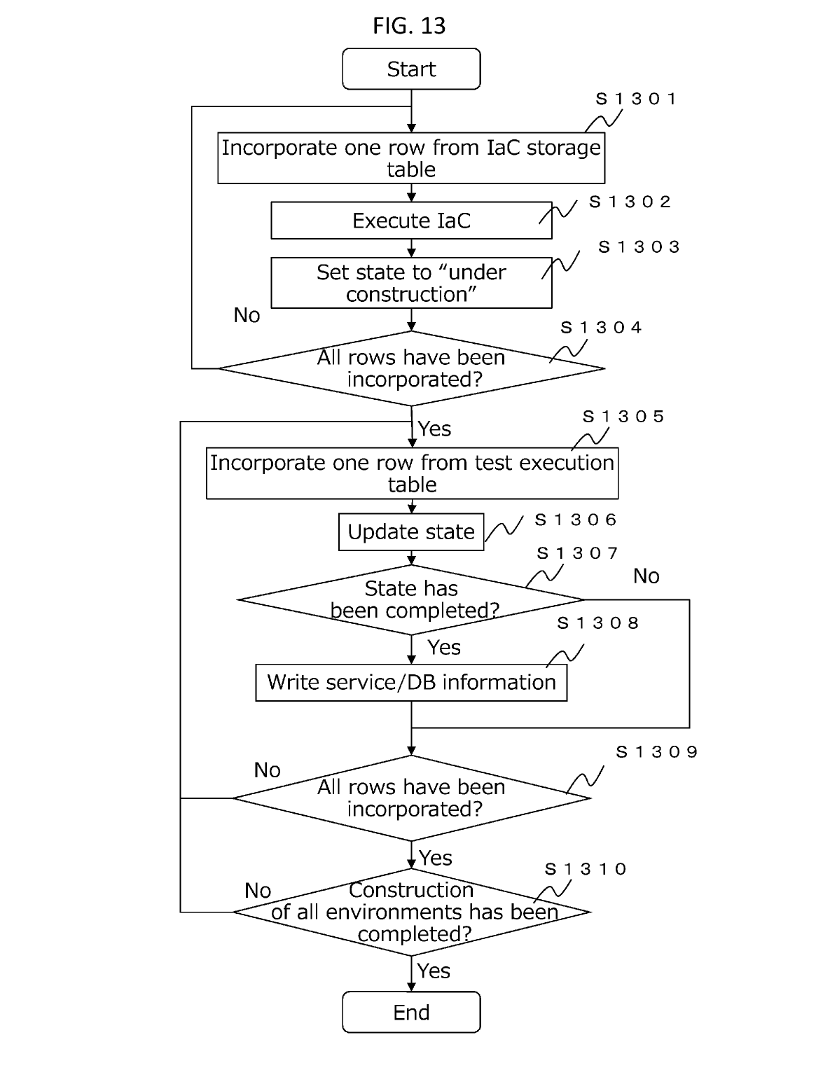

FIG. 13 is a flowchart showing a detailed flow of the testing environment construction processing.

The testing environment construction processing 203 is a processing realized by the processor 11 executing a software program, and the testing environment construction processing 203 can be said to be the operating entity. The processing is now described below with the testing environment construction processing 203 as the entity.

The testing environment construction processing 203 is called as soon as the application 31 is executable such as after the latest source code of the application 31 is built late at night, for example, and prior to the execution of the test execution processing 204.

First, the testing environment construction processing 203 incorporates one row from the IaC storage table 215 (S1301). The testing environment construction processing 203 then reads an IaC file from a location stored in the changed IaC 93 of the row incorporated in step S1301, executes the IaC, and starts construction of a testing environment (S1302). Next, in the testing environment construction processing 203, from the test execution table 216 a value of the state 1203 of a row in which the testing environment 1201 has a value equivalent to the value of the testing environment 91 of the row incorporated in step S1301 is set as “under construction” (S1303). Thereafter, the testing environment construction processing 203 determines whether or not incorporation of all rows from the IaC storage table 215 has been completed or not (S1304). Since incorporation of a row from the IaC storage table 215 means that testing environment construction has started by the execution of the IaC for said row, whether the construction of testing environments for all rows have started or not is determined.

If there are rows that have not yet been incorporated, that is, if there are rows that have not yet been subjected to testing environment construction, the testing environment construction processing 203 returns to step S1301 to incorporate a subsequent row. If all the rows have been incorporated, that is, if testing environment construction for all the rows has started, the testing environment construction processing 203 proceeds to step S1305.

In step S1305, the testing environment construction processing 203 incorporates one row from the test execution table 216. Thereafter, the testing environment construction processing 203 acquires a progress of the IaC corresponding to the value of the testing environment 1201 for the row acquired in step S1305, and updates the state 1203 for this row in the test execution table 216 to said progress (S1306). The progress can be, in addition to “under construction,” “completed” indicating that environment construction has completed, rollback indicating that a problem has occurred during environment construction and therefore the environment construction is rewound, and “rollback completed” indicating that the rewinding of the environment construction has completed.

Further, the testing environment construction processing 203 determines whether the value of the state 1203 updated in step S1306 is the “completed” or not (S1307). If the value of the state 1203 is the “completed,” the testing environment construction processing 203 acquires information necessary for access such as the representative IP address and/or DNS name of the service and database created by the IaC, and stores the information in the service 1204 and database 1205 of the row in the test execution table 216 (S1308).

Thereafter, the testing environment construction processing 203 determines whether the values of the states 1203 for all the rows held in the test execution table 216 are “completed” or “rollback completed” (S1310). If the values of the states 1203 of all the rows are “completed” or “rollback completed,” the testing environment construction processing 203 ends the processing. If the values of the states 1203 are “under construction” or “rollback in progress,” the testing environment construction processing 203 returns to step S1305.

Test Execution Processing 204

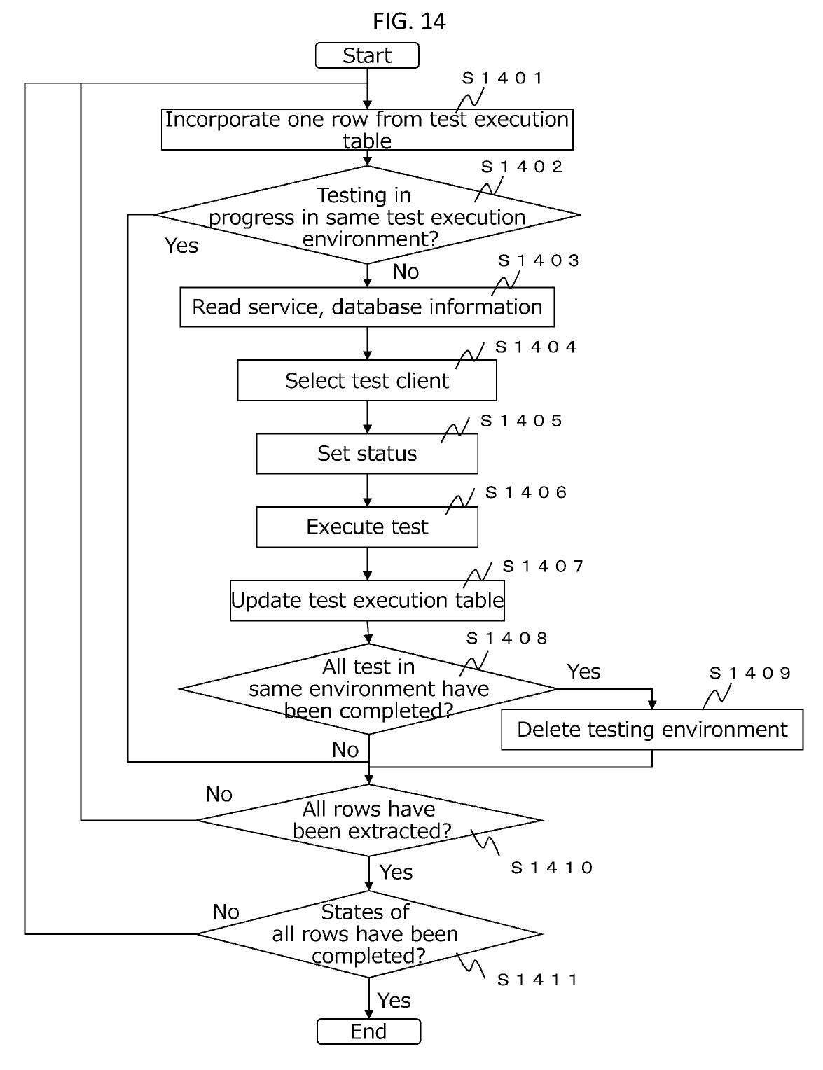

FIG. 14 is a flowchart showing a detailed flow of the test execution processing.

The test execution processing 204 is a processing realized by the processor 11 executing a software program, and the test execution processing 204 can be said to be the operating entity. The processing is now described below with the test execution processing 204 as the entity.

The test execution processing 204 first incorporates one row from the test execution table 216 (S1401). Next, the test execution processing 204 compares the list of test items being executed with the value of the testing environment 1201 for the row extracted in step S1401, for each testing environment held inside, and determines whether or not there are test items being executed in the testing environment of the same resource configuration as the testing environment 1201 extracted in step S1401 (S1402). If there are test items being executed in the same testing environment as the testing environment 1201 of the row extracted in step S1401, the test execution processing 204 proceeds to step S1410 or otherwise proceeds to step S1403.

In step S1403, the test execution processing 204 extracts the values of the service 1204 and the database 1205 for the row extracted from the test execution table 216 in step S1401.

Next, the test execution processing 204 selects a test client used in a test (S1404). Specifically, from the test item/resource mapping table 214, a row that has the same value of the ID 71 as the value of the test ID 1202 for the row extracted from the test execution table 216 in step S1401 is extracted, and the values of the client performance 72 and the client concurrent use 73 for said row are referenced. If the value of the client concurrent use 73 is “unavailable,” a test client with a performance corresponding to the value of the client performance 72. The test client may be an instance or a container or a service provided by a private cloud that tentatively secures a compute resource and executes a program. The location where a test client is generated may or may not be on the public cloud as long as the location can communicate with a service. If the value of the client concurrent use 73 is “available,” an already generated test client is selected. However, in a case where the number of testing environments that are already allocated is a predetermined number or more, a new test client may be generated.

Subsequently, if a specific status needs to be set to a faulty application, the test execution processing 204 sets said status (S1405). Specifically, from the test item table 211, a row in which the value of the test ID 41 matches the value of the test ID 1202 of the row extracted in step S1401 is extracted, and the values of the target resource 45 and the status 46 of said row are referenced. Then, using a service that is provided by a public cloud such as FIS (Fault Injection Service) of AWS and intentionally generates a failure, the status is set by designating a resource by using the value of the service 1204 of the row extracted in step S1401 if the target resource 45 is “service,” and similarly designating a resource by using the value of the database 1205 of the row extracted in step S1401 if the target resource 45 is “DB,” and calling the API corresponding to the status 46. If the value of the target resource 45 is “-” and the value of the status 46 is “normal,” then it means that the test is performed when the application is running normally, and therefore no status is set.

Next, the test execution processing 204 transmits a request message to the value of the service 1204 of the row extracted in step S1401, the request message being created using the value of the API 42 of the row of the test item table 211 extracted in step S1405 and the value of the parameter 43 (S1406). Accordingly, the test is executed by the service of the application 31, and a response message is transmitted. Of the response message received from the service matches the action 44, the test results in success, but if the response message does not match the action 44, the test results in failure.

Next, the test execution processing 204 sets the value of the state 1203 of the row extracted in step S1401 to “completed,” and updates the test execution table 216 so that the value of the result 1206 of the row becomes the test result of step S1406 (S1407). Thereafter, the test execution processing 204 determines, in the test execution table 216, whether the states 1203 of all the rows having the same value of the testing environment 1201 as the testing environment 1201 of the row extracted in step S1401 are “completed” or not (S1408). Then, if the values of the states 1203 of all the rows are “completed,” the test execution processing 204 proceeds to step S1409, and if there exist rows where the states 1203 are not yet “completed,” the test execution processing 204 proceeds to step S1410.

In step S1409, the test execution processing 204 deletes the testing environments for all the rows where the states 1203 are “completed.” Specifically, in case of CloudFormation of AWS, stack names that are designated at the time of testing environment construction may be designated again, and a delete command may be executed.

Thereafter, the test execution processing 204 determines whether the row to be processed that is extracted in step S1401 is the last row in the test execution table 216 or not (S1410). If the row to be processed is the last row in the test execution table 216, the test execution processing 204 proceeds to step S1411. If the row to be processed is not the last row in the test execution table 216 and there exist other rows remaining, the test execution processing 204 returns to step S1401. In step S1411, the test execution processing 204 determines whether the states 1203 for all the rows in the test execution table 216 are “completed” or not (S1411). If there exist rows in the test execution table 216 in which the values of the states 1203 are not “completed,” the test execution processing 204 resets the information of the rows being read, and returns to step S1401. If the values of the states 1203 for all the rows in the test execution table 216 are “completed,” the test execution processing 204 ends the processing.

Test Execution Status Presentation Processing 205

The test execution status presentation processing 205 is the processing for displaying an execution status of a test on a screen and present it to the user. The test execution status presentation processing 205 is a processing realized by the processor 11 executing a software program, and the test execution status presentation processing 205 can be said to be the operating entity. The processing is now described below with the test execution status presentation processing 205 as the entity.

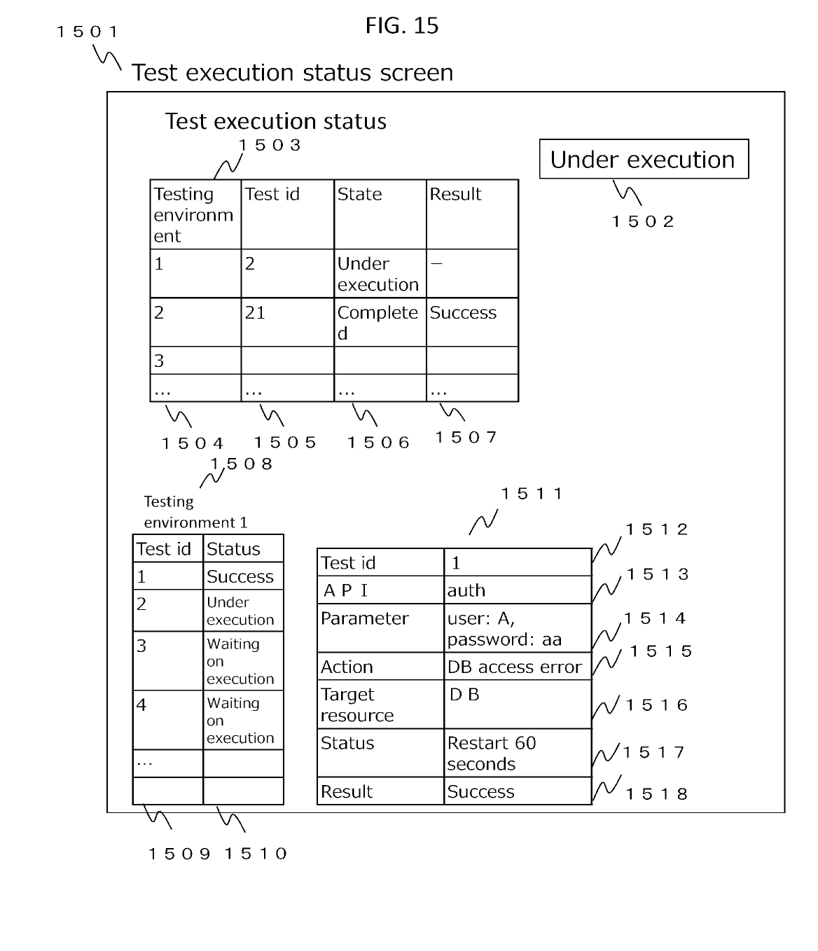

FIG. 15 is a diagram showing an example of a test execution status screen displayed by the test execution status presentation processing.

A test execution status screen 1501 includes a character string area 1502 showing execution statuses of entire tests including a plurality of tests. If the values of the states 1203 for all rows in the test execution table are “completed,” the test execution status presentation processing 205 displays “completed” in the character string area 1502. If the test execution table has rows in which the values of the states 1203 are not “completed,” the test execution status presentation processing 205 displays “under execution” in the character string area 1502.

The test execution status screen 1501 includes an area 1503 showing a status of each test. The status of each test is displayed in the form of a table in the area 1503. For each test, a testing environment 1504, a test ID 1505, a state 1506, and a result 1507 are displayed in the table. The test execution status presentation processing 205 displays, in the testing environment 1504, the values of the testing environment 1201 of the test execution table 216. Further, the test execution status presentation processing 205 displays the values of the test ID 1202 in the test ID 1505. The test execution status presentation processing 205 displays the values of the state 1203 in the state 1506. The test execution status presentation processing 205 displays the values of the result 1206 in the result 1507.

The test execution status screen 1501 further includes an area 1508 showing a test execution status of a testing environment selected by the user. The execution status of a test is displayed in the form of a table in the area 1508. The test execution status presentation processing 205 displays, in the area 1508, a test execution status of a testing environment corresponding to the value of the testing environment 1504 for a row of the area 1503 selected by the user. In addition to a testing environment name, a test ID 1509 and a test execution status 1510 of a test executing in a relevant testing environment are displayed in the area 1508. In the test ID 1509 and the status 1510, the test execution status presentation processing 205 displays the values of the test ID 1202 and the state 1203 of the row in which the value of the testing environment 1201 of the test execution table 216 matches the testing environment 1504 of the row selected in the area 1503.

The test execution status screen 1501 also includes an area 1511 showing detailed information on the test selected by the user. The detailed information on the test are displayed in the form of a table in the area 1511. Specifically, as information on a test items of the row selected in the area 1508 by the user, the test ID 1509, an API 1513, a parameter 1514, an action 1515, a target resource 1516, a status 1517, and a result 1518 are displayed. The test execution status presentation processing 205 acquires, from the test item table 211, the values of the API 42, the parameter 43, the action 44, the target resource 45, and the status 46 of the row in which the value of the test ID 41 matches the ID 1509 of the row selected in the area 1508, and displays the value in the API 1513, the parameter 1514, the action 1515, the target resource 1516, and the status 1517 in the area 1511. The test execution status presentation processing 205 also displays, in the result 1518 of the area 1511, the value of the result 1206 of the row having an test ID, in which the value of the test ID 1202 of the test execution table 216 matches the test ID 1509 of the row selected in the area 1508.

As described above, according to the test execution device 10 of the present embodiment, in application development where testing of various items needs to be executed, the time it takes for the entire testing can be reduced by constructing testing environments for resource configurations that suppress costs of using a public cloud and executing tests in parallel in the respective testing environment.

### Embodiment 2

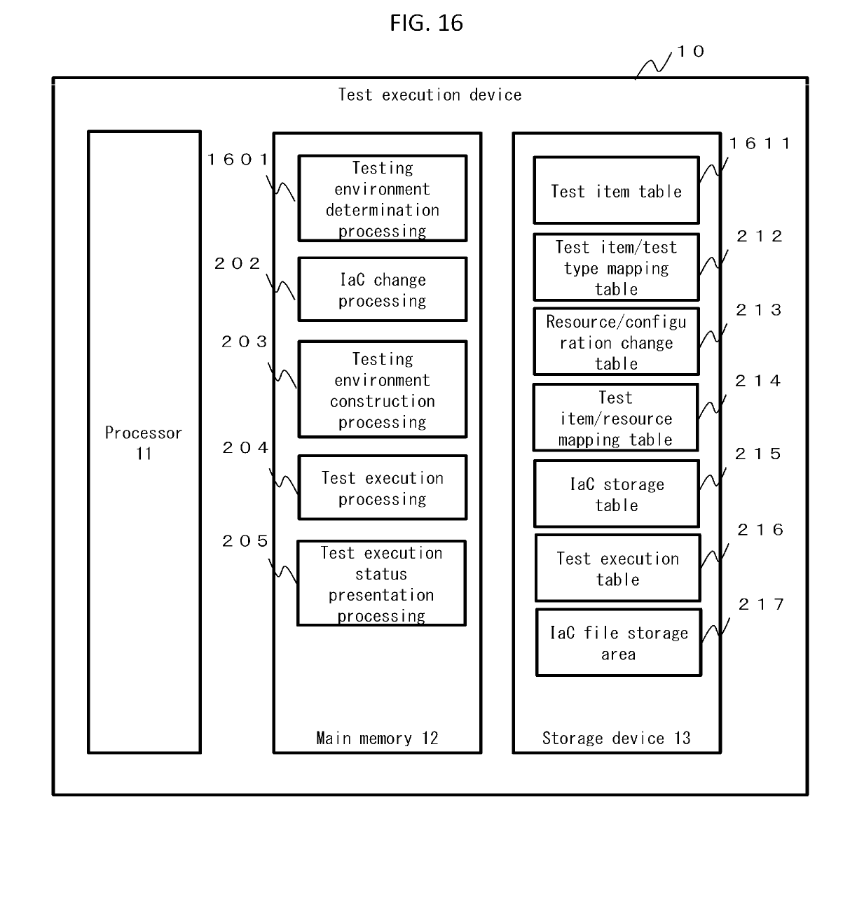

Embodiment 2 is now described with reference to FIGS. 16 to 18.

FIG. 16 is a block diagram showing a configuration of a test execution device according to Embodiment 2. In the test execution device of Embodiment 2 shown in FIG. 16, the same reference signs are given to the configurations and processing common to the test execution device of Embodiment 1 shown in FIG. 1, and overlapping descriptions are omitted accordingly.

Referring to FIG. 16, the test execution device 10 of Embodiment 2 has a testing environment determination processing 1601 and a test item table 1611 instead of the testing environment determination processing 201 and the test item table 211 of the test execution device 10 of Embodiment 1.

Testing Environment Determination Processing 1601

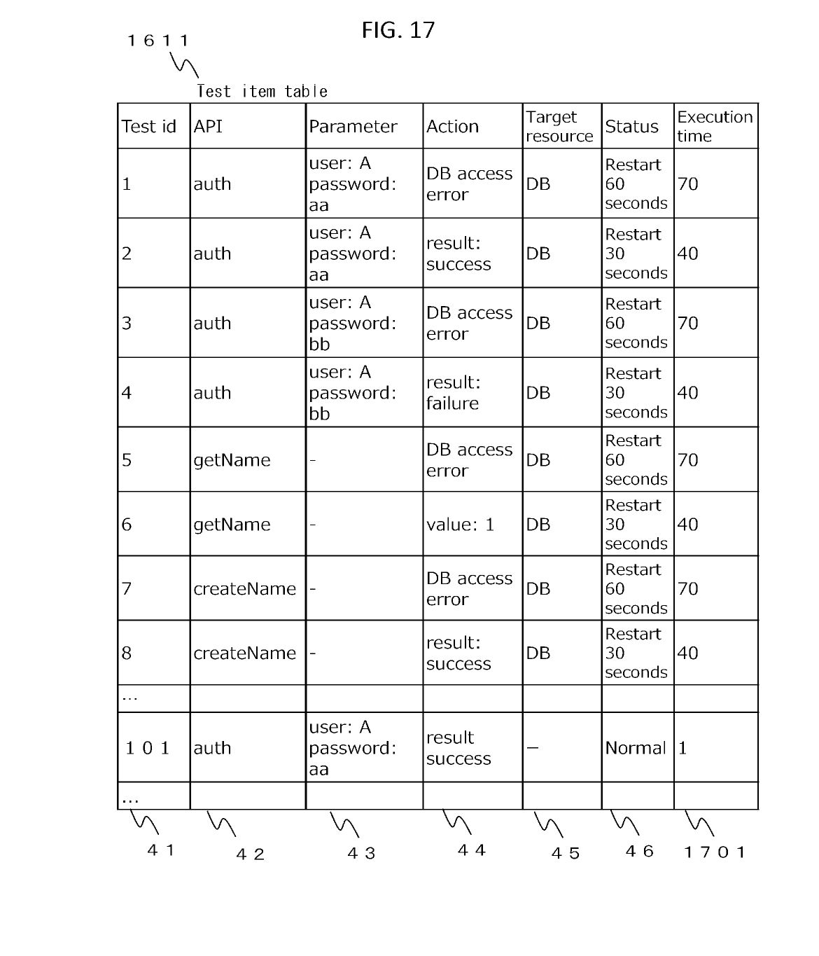

FIG. 17 is a diagram showing an example of the test item table of Embodiment 2.

The test item table 1611 is obtained by adding an execution time 1701 to the test item table 211 of Embodiment 1. The time (seconds) it takes for the execution of each test is stored in the execution time 1701. The time it takes for the execution of each test may be a time predicted from the contents of the test, the maximum value or average value of the time required in executing the past same test, or a value predicted using machine learning on the basis of data of the time required in executing a past test.

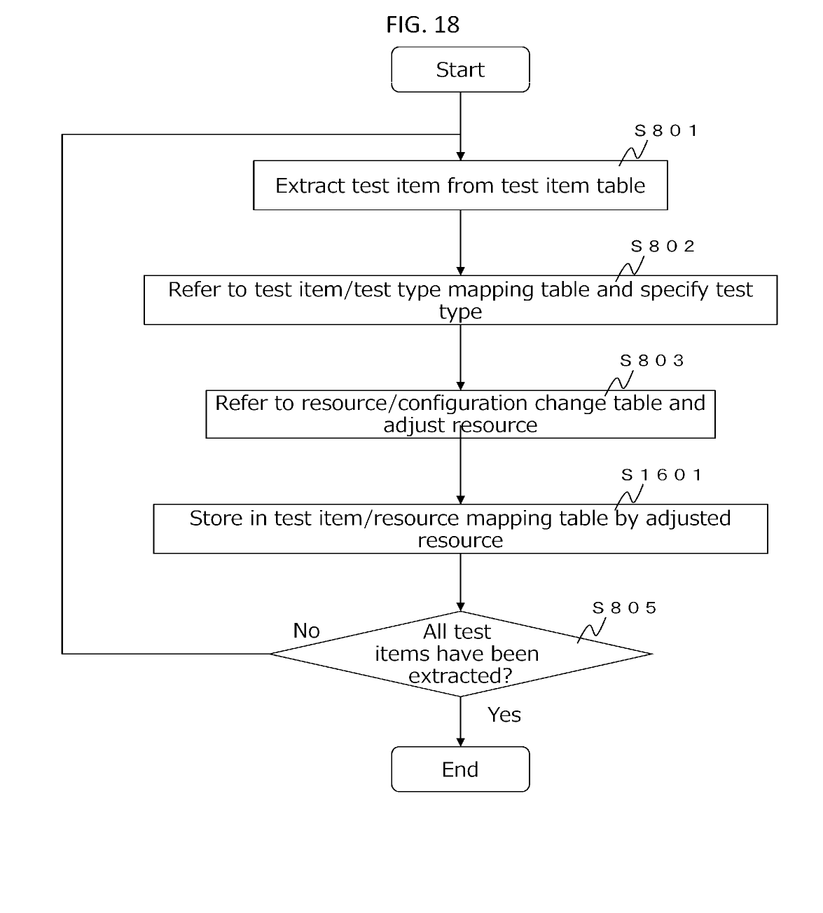

FIG. 18 is a flowchart showing a flow of the testing environment determination processing of Embodiment 2.

The testing environment determination processing 1601 is a processing realized by the processor 11 executing a software program, and the testing environment determination processing 1601 can be said to be the operating entity. The processing is now described below with the testing environment determination processing 1601 as the entity.

Referring to FIG. 18, in Embodiment 2, after executing processing of the same steps S801, S802, S803 as those of Embodiment 1, the testing environment determination processing 1601, in step S1601, inserts a new row in the test item/resource mapping table 214 on the basis of the information on the table obtained by the processing of steps S801, S802, S803.

In doing so, as a value for each column in the new row, first, the value of the ID 41 in the test item table 211 extracted in step S801 is copied to the test ID 71. Here, the number of rows having a specific value of the test type 62 in the resource/configuration change table 213 is the number of resource types. In the present embodiment, there are three types, “DB,” “service,” and “test client.” Thus, from the rows in the resource/configuration change table 213 where the values of the resource type 61 show “DB,” the values of the redundant configuration 63 are copied to the DB redundant configuration 77 in the new rows and the values of the performance 64 are copied to the DB performance 76 in the new rows. Subsequently, from the rows in the resource/configuration change table 213 where the values of the resource type 61 show “service,” the values of the redundant configuration 63 are copied to the service redundant configuration 75 in the new rows and the values of the performance 64 are copied to the service performance 74 in the new rows. Then, from the rows in the resource/configuration change table 213 where the values of the resource type 61 show “test client,” the values of the performance 64 are copied to the client performance 72 in the new rows and the values of the parallelizability 65 are copied to the client concurrent use 73 in the new rows. Up to this point, the same processing as S804 of Embodiment 1 is performed, and the subsequent processing differs from S804 of Embodiment 1.

First, the testing environment determination processing 1601 determines whether or not the existing rows that are inserted thus far in the test item/resource mapping table 214 have rows that completely match with the new rows in terms of the values of the client performance 72, the client concurrent use 73, the service performance 74, the service redundant configuration 75, the DB performance 76, and the DB redundant configuration 77. If there are existing rows that completely match with the new rows in terms of the values of the client performance 72, the client concurrent use 73, the service performance 74, the service redundant configuration 75, the DB performance 76, and the DB redundant configuration 77, the testing environment determination processing 1601 internally holds an integrated value obtained by calculating the sum of values stored in the execution time 1701 of the test item table 1611 for the values of the respective testing environments. Then, the testing environment determination processing 1601 determines whether a total integrated value obtained by adding the execution time of a test item to be processed to the integrated value exceeds a predetermined threshold or not. For example, if a testing is performed from 1AM to 6AM in order to complete all the tests late at night, the threshold may be 5 hours (300 minutes, 18000 seconds).

If there are existing rows that completely match with the new rows in terms of the values of the client performance 72, the client concurrent use 73, the service performance 74, the service redundant configuration 75, the DB performance 76, and the DB redundant configuration 77, and the total integrated value does not exceed the threshold, the testing environment determination processing 1601 copies the values of the testing environment 78 of the existing rows that completely match with the new rows in terms of the values of the client performance 72, the client concurrent use 73, the service performance 74, the service redundant configuration 75, the DB performance 76, and the DB redundant configuration 77, to the testing environment 78 of the new rows. If there are existing rows that completely match with the new rows in terms of the values of the client performance 72, the client concurrent use 73, the service performance 74, the service redundant configuration 75, the DB performance 76, and the DB redundant configuration 77, and the total integrated value does not exceed the threshold, or if there are no existing rows that completely match with the new rows in terms of the values of the client performance 72, the client concurrent use 73, the service performance 74, the service redundant configuration 75, the DB performance 76, and the DB redundant configuration 77, the testing environment determination processing 1601 stores a value obtained by adding 1 to the maximum value of the testing environment 78 into the testing environment 78 of the new rows if there are rows that are inserted thus far into the test item/resource mapping table 214, and stores 1 to the testing environment 78 of the new rows if the test item/resource mapping table 214 is empty, that is, if there are no existing rows.

As described above, in the present embodiment, by constructing testing environments and separately executing tests so that the execution time for each testing environment does not exceed the threshold, costs can be kept down while reducing the time it takes for a test to the required time.

The embodiments described above are examples to illustrate the present invention and are not intended to limit the claims of the present invention thereto. Those skilled in the art can implement the present invention in various other ways without departing from the gist of the present invention.

The embodiments described above include the following items. However, the items included in the present embodiment are not limited to the ones described below.

Item 1

A test execution device for executing a plurality of tests on an application, comprising a memory and a processor, wherein the memory is configured to store management information that enables, for each of the tests, specifying a resource configuration of a testing environment where each of the tests can be executed, and the processor is configured to specify, based on the management information, a resource configuration of a testing environment used for execution of each of the tests, aggregate the tests for the respective resource configurations, construct a testing environment for each of the resource configurations, and sequentially execute, in the testing environments, the tests aggregated for the resource configurations of the testing environments. Accordingly, since the tests are aggregated for the respective resource configurations of the testing environments, each testing environment is constructed, tests are sequentially executed for the respective testing environments, and resources of the testing environments where all the tests are completed are deleted, costs can be kept down while reducing the time it takes for a test.

Item 2

In the test execution device according to item 1, the management information is also information that enables, for each of the tests, specifying an execution time which is the time it takes for executing each of the tests, and in a case where a sum of execution time of the tests aggregated for the respective resource configurations exceeds a predetermined threshold, the processor divides the tests aggregated for the respective resource configurations into a plurality of tests, constructs a plurality of testing environments for the resource configurations, and executes these tests separately for the plurality of resource configurations. Therefore, by constructing the testing environments so that the execution time for each testing environment does not exceed the threshold, costs can be kept down while reducing the time it takes for a test to the required time.

Item 3

In the test execution device according to item 1, the application is software running on a public cloud, the testing environment is constructed on the public cloud, and when all the tests aggregated for the resource configurations of the respective testing environments are finished, the processor deletes resources of the testing environments on the public cloud. Accordingly, since resources of the testing environments are deleted when all the tests aggregated for the resource configurations of the respective testing environment are finished, usage fees for the resources of the public cloud can be kept low.

Item 4

In the test execution device according to item 1, the memory stores a test item/test type mapping table defining test types for the respective tests, and a resource/configuration change table defining resource configurations required for the test types, and the processor generates a test item/resource mapping table indicating resource configurations required for the respective tests on the basis of the test item/test type mapping table and the resource/configuration change table, and specifies a resource configuration of a testing environment used for executing each of the tests on the basis of the test item/resource mapping table. Thus, by previously defining the test types for the respective tests and resource configurations required for the test types, resource configurations of testing environments can be specified easily.

Item 5

In the test execution device according to item 4, the resource/configuration change table defines, for each test type, how many resources can be deleted or reduced from the original execution environment to obtain a testing environment. Therefore, since testing can be executed in a testing environment obtained by deleting or reducing resources from the original operating environment, costs can be reduced effectively.

Item 6

In the test execution device according to item 5, the resources include a service providing a computing function and a database providing a database function, and the testing environments are defined by a performance and a redundant configuration required for each of the service and the database. Thus, since testing can be executed in a testing environment obtained by possibly deleting or reducing services and/or databases from the original operating environment, costs can be reduced effectively.

Item 7

In the test execution device according to item 6, the resources further include a client, and the testing environments are defined by a performance required for the client and the availability of concurrent use with other tests. Thus, since testing can be executed in a testing environment obtained by possibly deleting or reducing clients from the original operating environment, costs can be reduced effectively.

Item 8

In the test execution device according to item 1, the processor generates information for displaying a progress of a test execution for each of the testing environments.

What is claimed is:

1. A test execution device for executing a plurality of tests on an application, the device comprising:
a memory; and
a processor, wherein
the memory is configured to store management information that enables, for each of the tests, specifying a resource configuration of a testing environment where each of the tests can be executed, and
the processor is configured to:
specify, based on the management information, a resource configuration of a testing environment used for execution of each of the tests;
aggregate the tests for the respective resource configurations;
construct a testing environment for each of the resource configurations; and
sequentially execute, in the testing environments, the tests aggregated for the resource configurations of the testing environments.

2. The test execution device according to claim 1, wherein
the management information is also information that enables, for each of the tests, specifying an execution time which is a time required for executing each of the tests, and
in a case where a sum of execution time of the tests aggregated for the respective resource configurations exceeds a predetermined threshold, the processor is configured to:
divide the tests aggregated for the respective resource configurations into a plurality of tests, construct a plurality of testing environments for the resource configurations, and execute these tests separately for the plurality of resource configurations.

3. The test execution device according to claim 1, wherein
the application is software running on a public cloud,
the testing environment is constructed on the public cloud, and
when all the tests aggregated for the resource configurations of the respective testing environments are finished, the processor deletes resources of the testing environments on the public cloud.

4. The test execution device according to claim 1, wherein the memory is configured to store:
a test item/test type mapping table defining test types for the respective tests; and
a resource/configuration change table defining resource configurations required for the test types, and
the processor is configured to:
generate a test item/resource mapping table indicating resource configurations required for the respective tests on the basis of the test item/test type mapping table and the resource/configuration change table; and
specify a resource configuration of a testing environment used for executing each of the tests on the basis of the test item/resource mapping table.

5. The test execution device according to claim 4, wherein the resource/configuration change table defines, for each test type, to what extent resources can be deleted or reduced from the original execution environment to obtain a testing environment.

6. The test execution device according to claim 5, wherein
the resources include a service providing a computing function and a database providing a database function, and
the testing environments are defined by a performance and a redundant configuration required for each of the service and the database.

7. The test execution device according to claim 6, wherein
the resources further include a client, and
the testing environments are defined by a performance required for the client and the feasibility of concurrent use with other tests.

8. The test execution device according to claim 1, wherein the processor is configured to generate information for displaying a progress of a test execution for each of the testing environments.

9. A test execution method for executing a plurality of tests on an application, the method comprising, by a computer:
storing management information that enables, for each of the tests, specifying a resource configuration of a testing environment where each of the tests can be executed;
specifying, based on the management information, a resource configuration of a testing environment used for execution of each of the tests;
aggregating the tests for the respective resource configurations;
constructing a testing environment for each of the resource configurations; and
sequentially executing, in the testing environments, the tests aggregated for the resource configurations of the testing environments.

10. A non-transitory computer-readable medium containing a test execution program for executing a plurality of tests on an application, the program causing a computer to:
store management information that enables, for each of the tests, specifying a resource configuration of a testing environment where each of the tests can be executed;
specify, based on the management information, a resource configuration of a testing environment used for execution of each of the tests;
aggregate the tests for the respective resource configurations;
construct a testing environment for each of the resource configurations; and
sequentially execute, in the testing environments, the tests aggregated for the resource configurations of the testing environments.
